(19) United States
(12) Patent Application Publication
(10) Pub. No.: US 2024/0346111 A1
(43) Pub. Date: Oct. 17, 2024

(54) Interpolant Pattern Matching

(71) Applicant: CrowdStrike, Inc., Irvine, CA (US)

(72) Inventor: Matthew Edward Noonan, Ithaca, NY (US)

(73) Assignee: CrowdStrike, Inc., Irvine, CA (US)

(21) Appl. No.: 18/301,720

(22) Filed: Apr. 17, 2023

(51) Int. Cl. G06F 17/17; G06F 9/455

(52) U.S. Cl. CPC G06F 17/17; G06F 9/45508

(57) ABSTRACT

Interpolant pattern matching reflects a runtime environment. Any interpolant finite automata (such as a DFA) using a regular expression may be modified with an interpolant string to create an interpolant finite automata (such as an IDFA). The interpolant string incorporates a placeholder that is then modified according to the runtime environment. An environmental variable or a directory path, for example, may be inserted into the placeholder at runtime. An input string may be pattern matched to the IDFA that reflects the runtime environment.

### BACKGROUND

The subject matter described herein generally relates to computers and, more particularly, the subject matter relates to regular expression pattern matching.

Pattern matching is vital in today's computerized world. Pattern matching is used by computers to search databases, to inspect network packets of data, and to detect harmful software. Indeed, pattern matching is especially useful for computer and network security, where strings of data are inspected for viruses, spyware, malware, network intrusions, and other threats. A problem with conventional pattern matching schemes, though, is a priori knowledge of the pattern. That is, the pattern-to-be-matched must be known ahead of time. This a priori knowledge of the pattern is especially problematic for some computer data. A computer's runtime data, for example, is only known at runtime. Conventional schemes thus cannot specify patterns that reflect an unknown runtime context.

### SUMMARY

Interpolant pattern matching greatly improves computer functioning. Database searches, malware detection, and deep packet inspection are improved by interpolant pattern matching that reflects a runtime environment. Interpolant pattern matching inspects text, files, packets, and other inputs for patterns. Some of the patterns may be safe or harmless. Other patterns, though, may be suspicious as possibly viruses, spyware, malware, network intrusions, or other threats. The interpolant pattern matching, though, incorporates one or more placeholders that are modified according to the runtime environment. An environmental variable, for example, may be inserted into the placeholder at runtime. An input string may then be pattern matched according to the runtime environment.

### BRIEF DESCRIPTION OF THE SEVERAL VIEWS OF THE DRAWINGS

The features, aspects, and advantages of cloud services malware detection are understood when the following Detailed Description is read with reference to the accompanying drawings, wherein:

FIGS. 1-3 illustrate some examples of interpolant pattern matching;

FIG. 4 illustrates more examples of the interpolant pattern matching;

FIG. 5 illustrates more examples using environmental variables;

FIG. 6 illustrates more examples using interpolant packet inspection;

FIG. 7 illustrates examples of credential protection;

FIGS. 8-9 illustrate examples using an interpolant deterministic finite automata (or IDFA);

FIG. 10 illustrates examples of a more detailed operating environment;

FIGS. 11-12 illustrate more detailed examples of the interpolant pattern matching;

FIGS. 13-17 illustrate more examples of the interpolant deterministic finite automata (or IDFA);

FIGS. 18-19 illustrate examples of cloud-based services;

FIG. 20 illustrates examples of a method or operations that improves computer functioning;

FIG. 21 illustrates more examples of a method or operations that interpolantly pattern match an input string;

FIG. 22 illustrates still more examples of a method or operations that interpolantly pattern match the input string; and

FIG. 23 illustrates a more detailed example of the operating environment.

### DETAILED DESCRIPTION

Some examples relate to interpolant pattern matching. Interpolant pattern matching is used to find emails, photos, documents, and other files on smart phones, computers, and networks. Interpolant pattern matching, though, may also be used to detect threats to computers and networks. Interpolant pattern matching accepts any input characters, such as text or strings of characters/bits. Interpolant pattern matching then matches those input characters to patterns. Some of the patterns may be safe or harmless. Other patterns, though, may be suspicious and perhaps indicate viruses, spyware, malware, network intrusions, or other threats. If the input characters match a safe pattern, then perhaps the interpolant pattern matching passes or approves the input characters for other downstream operations. However, if the input characters match a suspect pattern, then the interpolant pattern matching may flag the input characters as suspicious. The interpolant pattern matching may generate alerts and route the input characters for more detailed inspection.

Interpolant pattern matching, though, adds a runtime context. When a computer starts, or when an “app” is opened, the computer may enter a so-called runtime environment. The runtime environment also changes with different users, such as when the computer is shared by multiple users. The runtime environment sets or establishes many parameters and values that are important for the safe operation of the computer. Conventional pattern matching techniques, though, are blind to the runtime environment. That is, the conventional pattern matching techniques have no access to many parameters and values that are established by the runtime environment. The conventional pattern matching techniques are thus unable to inspect these runtime parameters and values for threatening patterns. The interpolant pattern matching, though, is able to access these important runtime parameters and values. The interpolant pattern matching utilizes an elegant mechanism that allows these parameters and values, established by the runtime environment, to be inspected for suspicious patterns.

Interpolant pattern matching thus significantly improves computer and network security. Security software heavily relies on pattern matching techniques to detect viruses, spyware, malware, network intrusions, or other threats. Yet, because the conventional pattern matching techniques are blind to the runtime environment, the runtime environment was conventionally vulnerable to attack. Now, though, security software incorporating the interpolant pattern matching is able to inspect the many parameters and values established by the runtime environment. Interpolant pattern matching is not blind to the runtime environment and provides greater computer and network security.

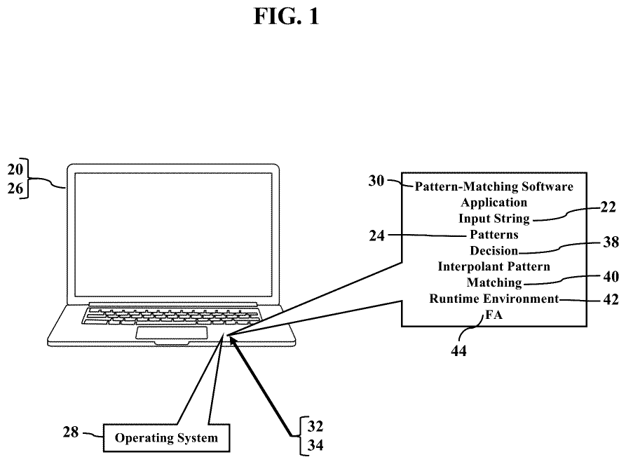

FIGS. 1-3 illustrate some examples of interpolant pattern matching. A computer system 20 is programmed to match an input string 22 to patterns 24. FIG. 1 illustrates the computer system 20 as a laptop computer 26, but the computer system 20 may be any processor-controlled device (as later paragraphs will explain). The laptop computer 26 stores and executes an operating system 28. The laptop computer 26 also stores a pattern-matching software application 30 in a memory device 32. The laptop computer 26 has a hardware processor 34 that reads and executes the pattern-matching software application 30. The pattern-matching software application 30 has programming code or instructions that cause the hardware processor 34 to perform operations, such as determining if the input string 22 matches any one or more of the patterns 24. The pattern-matching software application 30 may also cause the hardware processor 34 to generate a decision 38, such as a binary yes-or-no match. The decision 38 may also specify a matching one of the patterns 24.

Conventional pattern-matching schemes use regular expressions and static state machines. A conventional regular expression represents a textual representation of a pattern to be matched. The conventional regular expression is then converted to the conventional state machine. An input character is read and compared to the conventional state machine. As each character is read and compared, the conventional pattern-matching schemes traverse the static state machine until a match, or no match, is determined. Because the conventional regular expressions are static, the conventional state machine is defined in advance and reflects predetermined sequences of characters. The conventional state machine, in other words, must be compiled ahead of time to convert the conventional regular expression. This ahead-of-time compilation requirement makes it impossible to use data that is only available at run-time to construct patterns. Conventional pattern-matching schemes have no knowledge of the runtime context.

In FIG. 1, though, the computer system 20 performs interpolant pattern matching 40. The interpolant pattern matching 40 dynamically constructs the patterns 24 to reflect a real time runtime environment 42. The patterns 24, in other words, are interpolant and may dynamically change according to the runtime environment 42. As the laptop computer 26 operates in different runtime environments 42, many data values and file locations may change. These values and files may not be known until defined by the operating system 28 and/or until defined by starting some other application. In FIG. 1, the pattern-matching software application 30 instructs the hardware processor 34 to compare the input string 22 to an interpolant finite automata (or FA) 44. The interpolant finite automata 44 may dynamically change with the runtime environment 42. The interpolant finite automata 44 may be any deterministic finite automata (or DFA), non-deterministic finite automata (or NFA), or extensible finite automata (or eXFA) (as later paragraphs explain). Whatever the interpolant finite automata 44, the interpolant finite automata 44 may behaviorally change with the runtime environment 42. That is, the interpolant finite automata 44 may still be built or defined ahead of time, but the interpolant finite automata 44 incorporates data and files that are only known later during the runtime environment 42. The interpolant finite automata 44, in other words, may have a fixed structure or form, but, during operation, the interpolant finite automata 44 may change its behavior according to the runtime environment 42. The interpolant pattern matching 40 may thus dynamically change according to the runtime environment 42.

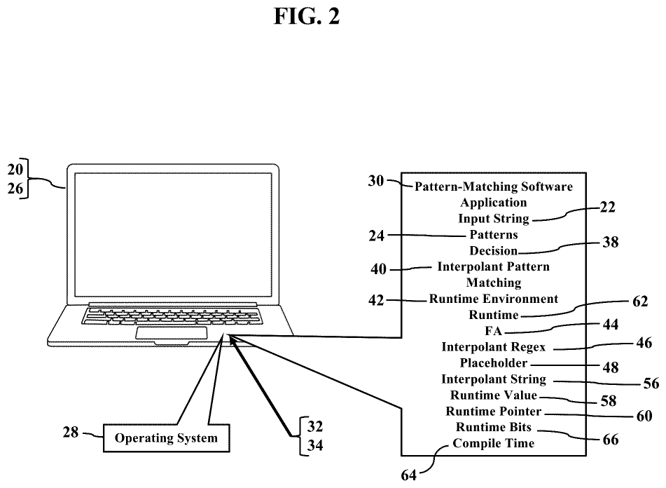

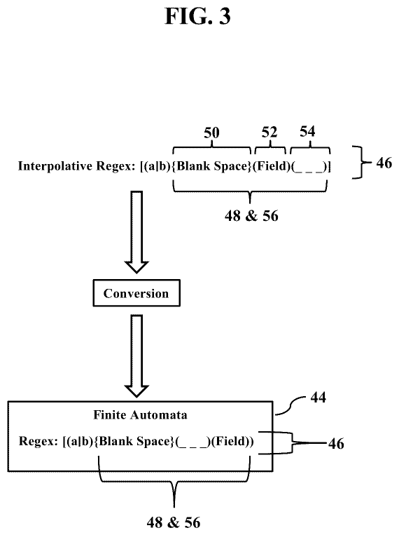

As FIGS. 2-3 illustrate, the interpolant finite automata 44 may represent one or more interpolant regular expressions (or regex) 46. Each interpolant regular expression 46 may have one or more runtime placeholders 48 that are populated or filled during the runtime environment 42. While the runtime placeholder 48 may have any structure, FIG. 3 illustrates blank spaces 50, bit fields 52, and/or null/empty bit positions 54. The runtime placeholder(s) 48 is/are reserved by an interpolant string 56. Once the runtime environment 42 is determined, the interpolant string 56 is then defined according to the runtime environment 42. The blank spaces 50, bit fields 52, and/or the null/empty bit positions 54 are filled by data set or established during the runtime environment 42. As a simple example, the interpolant string 56 may specify or reference a runtime value 58 defined during the current runtime environment 42. As another example, the interpolant string 56 may additionally or alternatively specify or reference a memory runtime pointer 60 defined by the runtime environment 42. The runtime value 58 and the runtime pointer 60 are unknown prior to a runtime 62, so each may change with the runtime environment 42. That is, the runtime value 58 and the runtime pointer 60 may only be specified at start or execution associated with the current runtime environment 42. The runtime value 58 and the runtime pointer 60, in other words, may be unknown at a compile time 64 and prior to the runtime 62. The interpolant regular expression 46 may thus incorporate the interpolant string 56 having the blank spaces 50, bit fields 52, and/or null/empty bit positions 54 that are filled or defined or referenced at or after the runtime 62.

The interpolant finite automata 44 may similarly be runtime dynamic. The interpolant finite automata 44 is constructed using the dynamically-changeable interpolant regular expression(s) 46. Because the interpolant regular expression 46 incorporates the dynamically-changeable interpolant string 56, the interpolant finite automata 44 also incorporates the dynamically-changeable interpolant string 56. The interpolant finite automata 44 similarly reserves or designates the blank spaces 50, bit fields 52, and/or null/empty bit positions 54 (representing the runtime value 58 and/or the runtime pointer 60) specified by the interpolant string 56. The interpolant finite automata 44 may thus populate or reference the interpolant string 56 at start or execution associated with the current runtime environment 42. The pattern-matching software application 30, for example, may receive runtime bits 66 representing the runtime value 58 and/or the runtime pointer 60 determined or defined during the runtime environment 42. The pattern-matching software application 30 may then insert or inject the runtime bits 66 into the interpolant string 56 incorporated into the interpolant finite automata 44. The pattern-matching software application 30 may thus compare the input string 22 to the runtime-changeable interpolant finite automata 44 expressing rules or bit combinations defined at the runtime 62.

The interpolant pattern matching 40 is especially useful in enterprise environments. Companies may have many different employees and their correspondingly many different computers. A large corporation, for example, may have thousands of employees and their thousands of computers. Each computer has a corresponding runtime environment 42. So, there could be thousands of different runtime environments 42. It would be essentially impossible to generate thousands of conventional regular expressions representing the thousands of different runtime environments 42. However, because the interpolant regular expression 46 is dynamically adaptable to different computers and their runtime environments 42, the interpolant pattern matching 40 uniquely reflects each different runtime environment 42.

The interpolant pattern matching 40 may match any character count. The interpolant finite automata 44 may be easiest to understand as when inspecting a single character at a time from within the input string 22. The interpolant pattern matching 40 may thus successively read each character and compare to the patterns 24. The interpolant pattern matching 40 may start from any character within the input string 22 (e.g., first, middle, or last), and the interpolant pattern matching 40 may linearly scan and compare in any direction (e.g., forward/backward or left/right). The interpolant pattern matching 40, however, may read and compare more than one character at a time. The interpolant pattern matching 40 may read chunks of characters from within the input string 22 according to any character-sized window desired. The interpolant pattern matching 40 may even be adapted to randomly read characters within the input string 22.

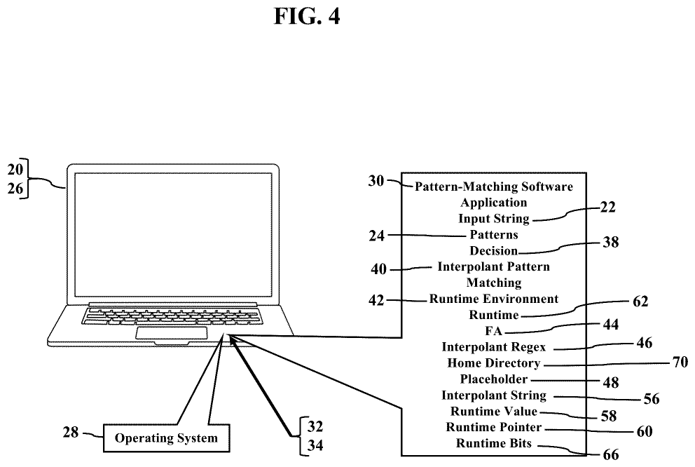

FIG. 4 illustrates more examples of the interpolant pattern matching 40. Suppose the interpolant regular expression 46 specifies the runtime value 58 as some data associated with a user's home directory 70. The home directory 70 may be defined as a path (such as name and location) by the operating system 28 during the runtime environment 42. The home directory 70, in particular, contains user files that are specific to a current user of the laptop computer 26. However, because the home directory 70 is unknown or undefined prior to the runtime 62 associated with the operating system 28, a conventional regular expression cannot be written or defined. The conventional pattern matching schemes have no knowledge of the runtime environment 42. The interpolant pattern matching 40, in contradistinction, defines the interpolant regular expression 46 using the runtime placeholder 48 within the interpolant string 56. The interpolant regular expression 46 may thus be written or expressed to match any files, locations, or bits associated with the home directory 70. Once the runtime environment 42 is determined, the pattern-matching software application 30 acquires the runtime bits 66 (representing the runtime value 58) and inserts or injects the runtime bits 66 into the interpolant finite automata 44 that incorporates the runtime placeholder 48 to the home directory 70. Here then, the runtime bits 66 represent the home directory 70. Because the interpolant regular expression 46 incorporates the placeholder(s) 48, the interpolant finite automata 44 is constructed or generated to also incorporate the placeholder(s) 48. The pattern-matching software application 30 may thus compare the input string 22 to the interpolant finite automata 44 expressing or specifying rules or bit combinations defining the home directory 70 at the runtime 62. The interpolant regular expression 46 may thus be built using the interpolant string 56. When the interpolant finite automata 44 runs or executes, the pattern-matching software application 30 fills the interpolant string 56 with the path (name and/or location) of the home directory 70.

The interpolant pattern matching 40 is especially useful for multi-user environments. If the laptop computer 26 is shared by multiple users, each different user will have a correspondingly different home directory 70. The single interpolant regular expression 46, though, may be defined to specify the home directory 70 as the placeholder(s) 48 in the interpolant string 56. Whenever the user changes, the corresponding change in the runtime environment 42 will revise or change the placeholder(s) 48. The interpolant finite automata 44 thus adapts and changes to the runtime environment 42. The single interpolant regular expression 46 is valid for the multiple users, even though their respective runtime environments 42 may differ.

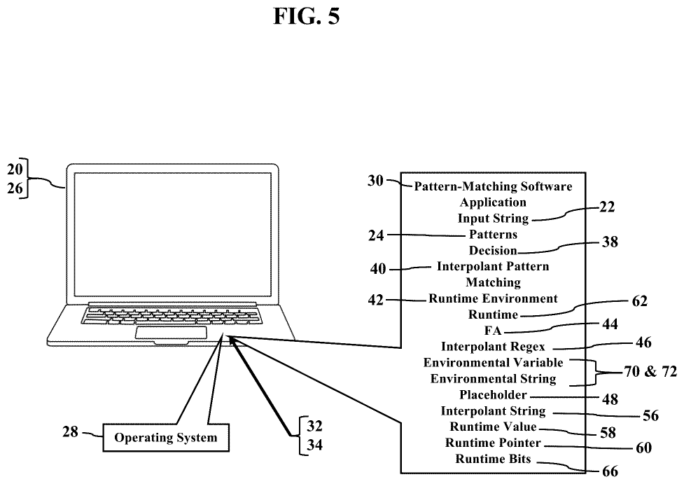

FIG. 5 illustrates more examples using environmental variables 70. As the computer system 20 (again illustrated as the laptop computer 26) operates, the environmental variables 70 may change with the runtime environment 42. Each environmental variable 70 may thus be a dynamic-named value that is associated with the runtime environment 42. For example, the interpolant regular expression 46 may express the interpolant string 56 using a name/location of a temporary (or TEMP) file as the runtime value 58. Other environmental variables 70 may include any values, parameters, or files associated with a home drive or home path, a terminal, a user profile, a registry, and/or a shell. There are numerous environmental variables 70, and the interpolant pattern matching 40 may use any environmental variables 70 specified by the operating system 28. Whatever the environmental variable 70, the interpolant regular expression 46 may incorporate the runtime placeholder 48 for the environmental variable(s) 70. Operationally, for example, the memory runtime pointer 60 may track or point to the corresponding environmental variable 70 as the interpolant finite automata 44 is processed. Once any environmental variable 70 is defined or determined, the pattern-matching software application 30 acquires the corresponding environmental bit string 72 that represents the environmental variable 70. The pattern-matching software application 30 inserts or injects the environmental bit string 72 into the placeholder 48 within the interpolant finite automata 44. The pattern-matching software application 30 may thus compare the input string 22 to the interpolant finite automata 44 and generate the decision 38, based on the current runtime environment 42. Examples of the interpolant pattern matching 40 may thus interpolate the environmental variable 70 into the interpolant finite automata 44 that was generated prior to the runtime 62.

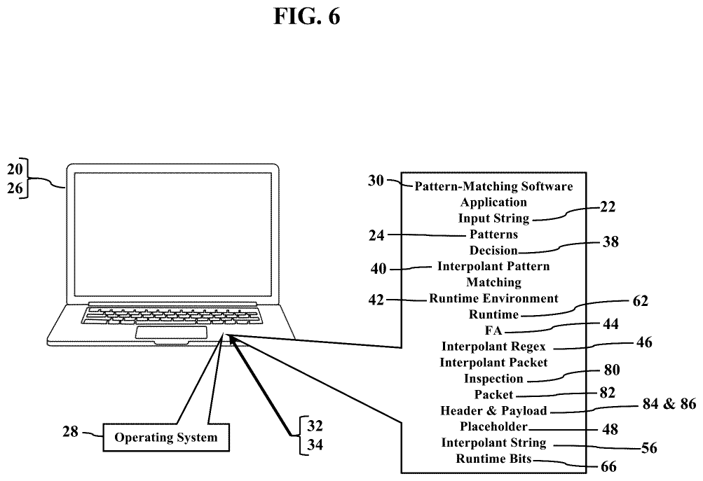

FIG. 6 illustrates more examples using interpolant packet inspection 80. The interpolant pattern matching 40 may be used to inspect a network packet 82 of data for suspicious bit patterns (e.g., malware, viruses, and other threats). The network packet 82 of data is structured according to a communications protocol. While the interpolant pattern matching 40 may be applied to any communications protocol, the TCP/IP (or Internet Protocol) is commonly used in computer networking and the Internet. The TCP/IP structures the network packet 82 of data as a header 84 and a payload 86. The interpolant pattern matching 40 may thus be used to compare bits contained within the header 84 and/or within the payload 86 portions to the patterns 24. Some of the patterns 24 may be bit combinations or bit sequences suspected of being harmful, and/or some of the patterns 24 may be harmless or permitted. The bit contents of the header 84 and/or the payload 86 portions may thus be used as the input string 22 to the interpolant finite automata 44. The interpolant finite automata 44 was/were previously generated or compiled using the interpolant regular expression (or regex) 46. Again, though, the interpolant regular expression 46 may have the runtime placeholder(s) 48 that is/are reserved within the interpolant string 56. When the interpolant finite automata 44 is/are constructed using the interpolant regular expression 46, the interpolant finite automata 44 similarly reserves or incorporates the placeholder(s) 48. Once the runtime environment 42 is known, the pattern-matching software application 30 obtains the runtime bits 66 that correspond to the runtime environment 42. The pattern-matching software application 30 may then insert or inject the runtime bits 66 into the interpolant finite automata 44, thus tailoring the interpolant finite automata 44 to the current runtime environment 42. The bit content of both the header 84 and the payload 86 may thus be pattern-matched to the current runtime environment 42.

The interpolant packet inspection 80 is especially useful for deep packet inspection. As worms, viruses, malware, and other software threats become more advanced and obfuscated, computer and network security must ever evolve and become ever more sophisticated. The interpolant packet inspection 80 may thus inspect both the header 84 and the payload 86 contents according to the current runtime environment 42. That is, the interpolant regular expression 46, and its corresponding interpolant finite automata 44, may specify rules representing safe and suspicious patterns 24 that are only known at the runtime 62.

Computer functioning is greatly improved. Because the interpolant packet inspection 80 reflects the current runtime environment 42, more malicious intrusions or attacks are detected with greater accuracy. Runtime files, APIs, and libraries that are only defined or used at or after the runtime 62 may be inspected. A bit string matching engine (such as the hardware processor 34 executing the pattern-matching software application 30) may compare, in real time or near-real time, the input string 22 (e.g., the header 84 and/or the payload 86) to a rule set (e.g., the patterns 24) contents. If a match is determined, the packet 82 of data may be flagged and offloaded for further threat analysis. If the input string 22 (representing the data packet 82) fails to match the patterns 24, then perhaps the data packet 82 is safe for downstream processing, routing, or delivery.

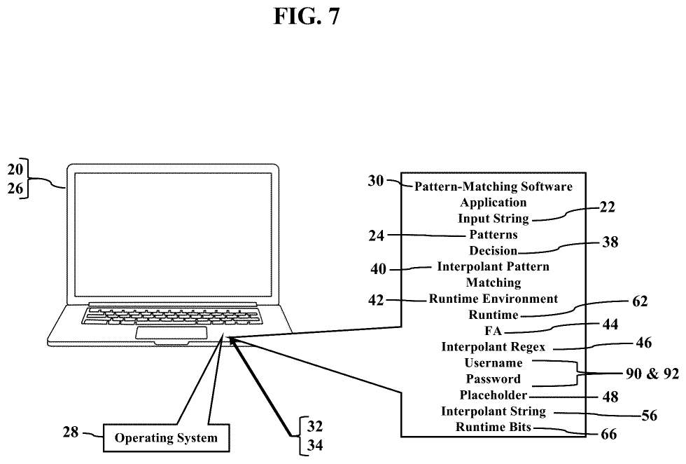

FIG. 7 illustrates examples of credential protection. Many software applications and cloud services require access credentials (such as a username 90 and a password 92). These credentials should be kept safe and secure. The interpolant regular expression 46 may thus be generated to inspect any data for characters matching the username 90 and/or the password 92. Outgoing messages (such as an electronic mail or text message), for example, may be interpolantly pattern matched for characters matching the username 90 and/or the password 92. Any documents or other file contents may also be interpolantly pattern matched for characters matching the username 90 and/or the password 92. When the interpolant regular expression 46 is generated, though, the username 90 and the password 92 are unknown. Indeed, the username 90 and the password 92 should never be revealed. The interpolant regular expression 46 may thus be generated with the runtime placeholder 48 representing the unknown username 90 and password 92. When the interpolant finite automata 44 is/are constructed, the interpolant finite automata 44 similarly reserves or designates the placeholder(s) 48 for the username 90 and password 92. But, once the interpolant finite automata 44 is running during the runtime environment 42, the pattern-matching software application 30 may have permission to access the username 90 and password 92 and to inject/insert bits representing the username 90 and password 92 into the interpolant finite automata 44. The pattern-matching software application 30 may then pattern match any emails, text messages, documents, files, and packets to the username 90 and password 92. If either the username 90 and/or the password 92 is matched, the pattern-matching software application 30 may generate a visual/audible alert and even block or deny the outgoing correspondence.

The interpolant pattern matching 40 may utilize any state machine. A bit string matching engine (e.g., the hardware processor 34 executing the pattern-matching software application 30) may apply the interpolant pattern matching 40 to any character or pattern matching scheme. For example, the interpolant pattern matching 40 may be implemented in a deterministic finite automata (or DFA), a non-deterministic finite automata (or NFA), or an extensible finite automata (or eXFA). The interpolant pattern matching 40, in other words, may be implemented regardless of the state machine. The interpolant finite automata 44 may be implemented in any state, node, state transition table, and/or state transition register. The interpolant finite automata 44 transitions from a present, initial state to a next, destination state in response to a character or bit associated with the input string 22. While the input string 22 may comprise characters from any language, the examples of the interpolant pattern matching 40 describe the character symbols from the American Standard Code for Information Interchange (or ASCII). A transition from a current character to a subsequent, destination character is governed by the rules or conditions defined according to characters in the patterns 24. As each next character (or bit) in the input string 22 is read, the character/bit is compared to the rules/conditions for transitioning from the current state (or character) to a subsequent state (or character). Even though the DFA, NFA, and eXFA may have different processes, and different advantages, for determining pattern matches, the interpolant pattern matching 40 may be implemented using the DFA, NFA, and eXFA.

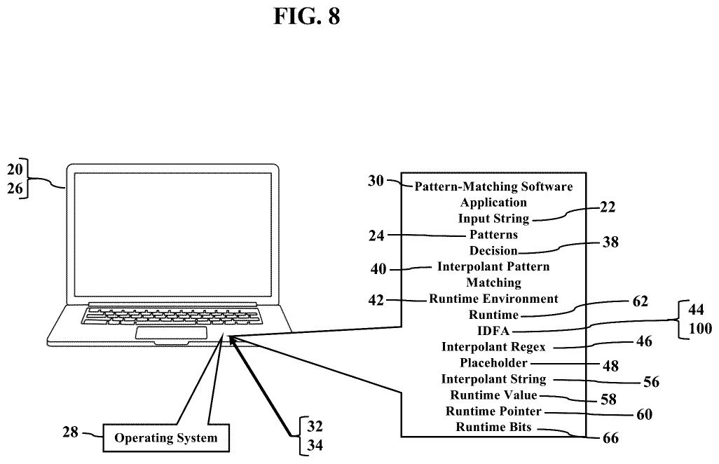

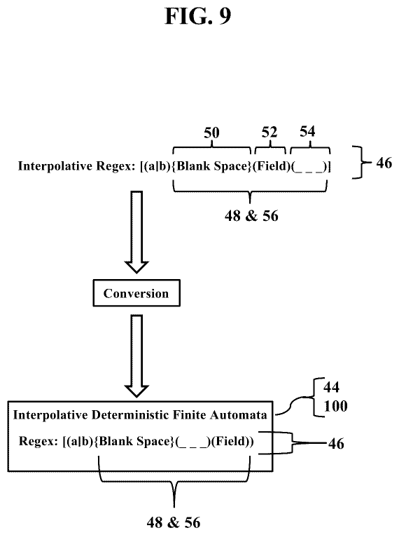

FIGS. 8-9 illustrate examples using an interpolant deterministic finite automata (or IDFA) 100. The interpolant finite automata 44 is implemented as a DFA using the interpolant pattern matching 40. The interpolant regular expression 46 incorporates the runtime placeholder(s) 48 (such as the blank space(s) 50, bit field(s) 52, and/or null/empty bit position(s) 54 illustrated in FIG. 9). The interpolant string 56 thus reserves or designates the placeholder 48 for runtime insertion of the runtime value 58 and/or the memory runtime pointer 60 defined by the runtime environment 42. The interpolant regular expression 46 is converted or compiled into the IDFA 100. The IDFA thus retains or references the interpolant string 56. At the runtime 62, then, the pattern-matching software application 30 receives the runtime bits 66 associated with the interpolant string 56. The pattern-matching software application 30 may then populate the interpolant string 56 with the runtime bits 66 that were set, defined, or established during the runtime environment 42. The pattern-matching software application 30 inserts or injects the runtime bits 66 into the interpolant string 56 referenced by the IDFA 100. Once any portion of the IDFA 100 is populated, the pattern-matching software application 30 may execute the IDFA 100 and pattern match a character/bit associated with the input string 22 to the IDFA 100.

Computer functioning is greatly improved. The IDFA 100 remains deterministic, but the IDFA 100 may now perform runtime string interpolation. A conventional DFA, however, must be compiled prior to the runtime 62 of the runtime environment 42. This ahead-of-time compilation requirement makes it impossible to use runtime data that is only available at the runtime 62 to construct the pattern 24. The conventional ahead-of-time DFA compilation model has no knowledge of the runtime context.

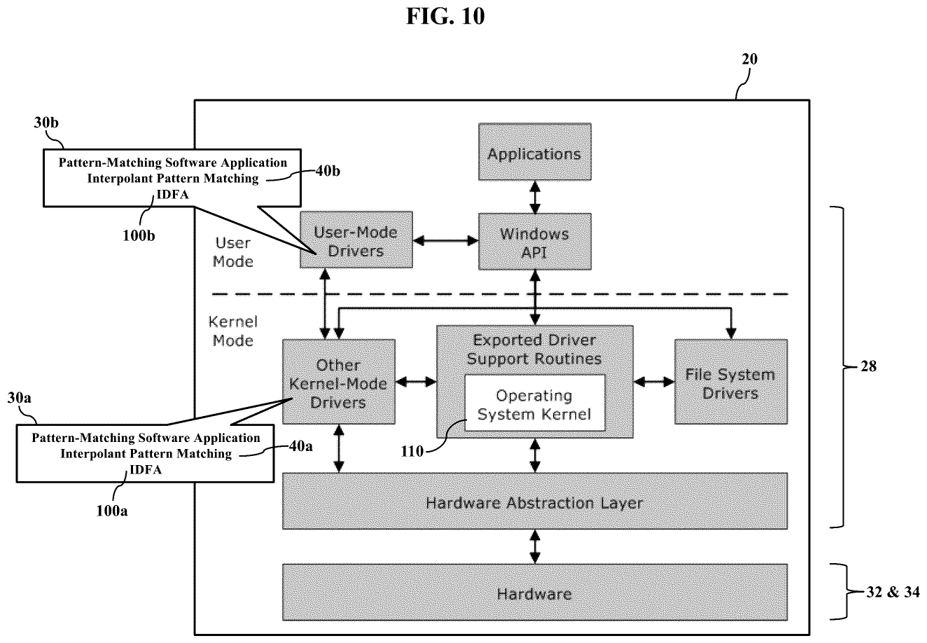

FIG. 10 illustrates examples of a more detailed operating environment. The interpolant pattern matching 40 may be implemented regardless of processor mode of operation. The computer system 20 has the hardware processor 34 that executes the operating system 28 stored in the memory device 32. A kernel 110 of the operating system 28 controls utilization and access to the hardware resources 32 and 34. The hardware processor 34 thus has a kernel mode and a user mode, and the hardware processor 34 switches between these two modes depending on what type of code is running on the hardware processor 34. The kernel 110 of the operating system 28, for example, loads and runs in the kernel mode that provides a protected kernel space or portion of the memory device 32. Some software applications store and execute from a user space of the memory device 32 associated with the user mode.

The pattern-matching software application 30 may execute in either mode. As FIG. 10 illustrates, the pattern-matching software application 30 may have kernel-mode components 30a having kernel permissions to the kernel mode. The pattern-matching software application 30 may also have user-mode components 30b in the user mode. The pattern-matching software application 30 may even load before the operating system 28, perhaps very early in the boot-time of the computer system 20. The pattern-matching software application 30 may be installed in the form of a driver (perhaps received from a remote cloud computing environment). Because the pattern-matching software application 30 may have the kernel-mode components 30a having kernel permissions to the kernel mode, the pattern-matching software application 30 may have kernel permissions to instrument/monitor/intercept functions, system calls, and other operations in the kernel mode. Moreover, because the pattern-matching software application 30 may also have the user-mode components 30b, the pattern-matching software application 30 may also instrument/monitor/intercept functions, system calls, and other operations in the user mode. The pattern-matching software application 30 may thus interface with the operating system 28 and with the software applications to receive any data (such as the runtime bits 66 associated with the runtime values 58 and/or the memory runtime pointer 60 that describe messages, input/output requests, system calls, reads/writes, launches, files, and memory allocations) associated with the runtime environment 42 (as explained with reference to FIGS. 2-9).

The pattern-matching software application 30 may execute the IDFA 100. Because the pattern-matching software application 30 may have the kernel-mode components 30a, the IDFA 100 may have kernel-mode components 100a that are executed in the kernel mode. Because the pattern-matching software application 30 may have the user-mode components 30b, the IDFA 100 may have user-mode components 100b that execute in the user-mode. When the pattern-matching software application 30a-b executes the IDFA 100a-b, the pattern-matching software application 30 may request and receive a full suite or description of the runtime values 58 representing the runtime environment 42 (as explained with reference to FIGS. 2-9). The pattern-matching software application 30 may send query requests specifying the runtime values 58, and the pattern-matching software application 30 may receive query responses specifying the runtime values 58. The pattern-matching software application 30 may additionally or alternatively register for the runtime values 58. The runtime values 58 may be received from the operating system 28 and/or from the software applications. The pattern-matching software application 30 may then populate the IDFA 100 with the runtime values 58.

The interpolant string 56 may have a fixed or variable bit length. The pattern-matching software application 30, for example, may bit count the interpolant string 56 to determine its bit size. The pattern-matching software application 30 may similarly bit count the environmental bit string 72, the home directory 70, and any other runtime value 58. The pattern-matching software application 30 may additionally or alternatively read/inspect predefined character(s) that specify a bit length for the interpolant string 56, the environmental bit string 72, the home directory 70, and any other runtime value 58. The runtime placeholder 48 may, or may, have a corresponding equal bit length. The interpolant pattern matching 40 may thus adapt and adjust to any bit size that is desired to implement the interpolant string 56.

Computer functioning is further improved. The IDFA 100 performs runtime string interpolation with a predictable memory usage. Because a conventional DFA must be compiled prior to the runtime 62 of the runtime environment 42, it would not be feasible nor desirable to perform conventional DFA compilation in a restricted context such (as the kernel mode). In particular, a conventional DFA compilation can have high computational cost and memory usage, which can make conventional DFA compilation impractical in a restricted context like the kernel, or a performance-sensitive context. The IDFA 100, in contradistinction, has predictable memory consumption based on the bit/byte size of the interpolant string(s) 56. The pattern-matching software application 30, implementing the IDFA 100, has low memory usage and predictable performance, which are important design and performance criteria in the kernel mode. The pattern-matching software application 30, implementing the IDFA 100, is thus an ideal security solution running within the operating system kernel 110.

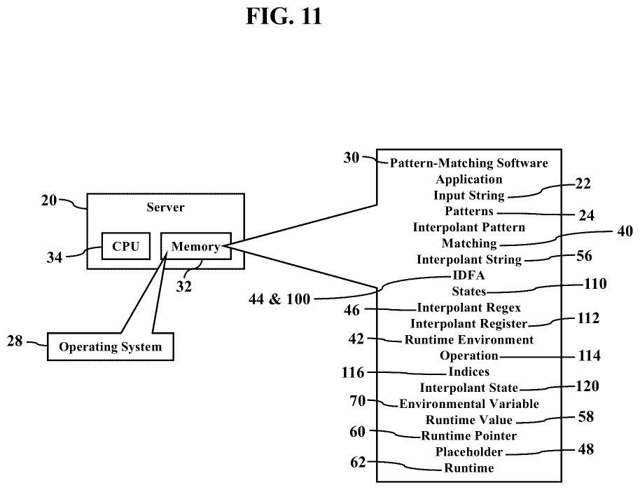

FIG. 11 illustrates more detailed examples of the interpolant pattern matching 40. The computer system 20 is illustrates as a server that implements the interpolant pattern matching 40. Each interpolant string 56 provides a runtime context when attempting a pattern match. The interpolant finite automata 44 (illustrated as the interpolant deterministic finite automata or IDFA 100) remains a collection of states 110. Some of the states 110 are accepting and others are rejecting or non-accepting states. Rules (such as expressed by the interpolant regular expressions 56) govern or define transitions between the states 110. The transitions may still be triggered by the characters, symbols, and/or bits associated with the input string 22. For simplicity, the IDFA 100 may permit at most one transition with a given input symbol leaving each state 110. The interpolant pattern matching 40, however, may be implemented using more than one transition between states 110. As FIG. 11 illustrates, the interpolant pattern matching 40 may introduce a number of interpolant registers 112 into the runtime context (e.g., the runtime environment 42). Each transition may be annotated with one or more operations 114 to perform on the interpolant registers 112. The interpolant registers 112 are used to hold a reference to one of the interpolant strings 56, along with a set of indices 116 into that interpolant string 56. Examples of the operations 114 may include:
i) Copy a value from one register to another;
ii) Set a register to (ref, {0}), where “ref” is a reference to one of the interpolant strings;
iii) Given an input symbol ‘c’, change the register's value from (ref, X) to (ref, {i+1: i in X such that ref [i]==c});
iv) Change the register's value from (ref, X) to (ref, {length (ref)}) if length (ref) is in X, or (ref, { }) otherwise; and/or
v) If R1 and R2 are two registers with the same interpolant reference ‘ref’ and index sets X1, X2, set R1 to (ref, X1 union X2).
   States 110 may also be equipped with predicates that can be used to test if the interpolant registers 112 are in an unacceptable state, in which case the IDFA 100 may halt and declare (e.g., such as the decision 38 illustrated in FIG. 1) that the input character was not a match. These operations 114 may suffice to create the IDFA 100 that can perform runtime string interpolation and has predictable execution time and memory usage. The actual memory usage now depends on the size of the interpolant strings 56, and the execution time is given by a number of register operations 114 which may be proportional to the size of the input string 22.

The interpolant pattern matching 40 may thus augment each state 110 with an additional, internal interpolant state 120. Each node, in other words, may be equipped its corresponding interpolant state 120 that transforms in a controlled way at transitions. Each node, for example, may include its corresponding internal interpolant state 120 as a username string interpolation that may vary from state-to-state, according to the particular username (such as the username 90 explained with reference to FIG. 7). The interpolant pattern matching 40 may thus vary from state to state according to a state type and a compilation strategy that implements the string 56 in interpolation. Each internal interpolant state 120, for example, may be pointed to according to the environmental variable 70. The interpolant register 112 may be considered a representation of the corresponding internal interpolant state 120. Each internal interpolant state 120, for example, may thus hold single integer values that represent locations in the input string 22. The internal interpolant states 120 represent sets of locations in one of the interpolate strings 56. The interpolant pattern matching 40 interpolates the runtime values 58, but the IDFA 100 is built ahead of time.

The interpolant register 112 may be a unique allocation. The interpolant register 112 may contain one or more of the runtime pointers 60. Each runtime pointer 60 may be a relatively large bit count. Many conventional registers imply a close mapping to a literal CPU register having a fixed width. These conventional registers merely store a number. The interpolant register 112, in contradistinction, stores or references the complex and composite interpolant string 56. The interpolant string 56 may thus be incorporated into the interpolant regular expression 46, and thus the IDFA 100, and reference the environmental variable 70 that is specified at the runtime 62. The interpolant register 112 may thus have a variable size that is far more complicated and descriptive than conventional schemes.

The interpolant register 112 may be allocated according to the bit length of the interpolant string 56. The interpolant register 112 is allocated within the memory device 32. The interpolant register 112, for example, may be allocated or called by the pattern-matching software application 30. The interpolant register 112, however, may be additionally or alternatively allocated or called by the IDFA 100. The IDFA 100 itself may specify an allocation of the required number of the interpolation registers 112, along with a corresponding bit length. Suppose, for example, that the path or filename to the home directory 70 (illustrated in FIG. 4) is one hundred (100) characters long, the interpolant registers 112 would be allocated to hold up to 100 different runtime pointers 60 into that interpolant string 56 representing the different character positions. That allocation may be performed by the pattern-matching software application 30 (or by whatever other component or engine is executing the IDFA 100).

The interpolant deterministic finite automata (or IDFA 100) thus includes the placeholders 48. The IDFA 100 produces a static artifact as a modified or extended DFA graph or table that still processes inputs in linear time, without exponential backtracking. Now, however, instead of allowing one input, the IDFA 100 allows that one input plus one or more of the interpolate strings 56. Each interpolant string 56 is injected into the pattern 24 to be matched at different nodal points. The IDFA 100 thus allows matches with the placeholder 48 that can be filled or defined at the runtime 62. The IDFA 100 still allows for linear time processing and constant memory overhead, which are two of the appealing features of DFA-based matching.

The IDFA 100 is populated post-compile. The interpolant regular expression 56 is compiled at the compile time 64 to generate or construct the IDFA 100. The compilation, in other words, happens once at the compile time 64 (illustrated in FIG. 2). Later, perhaps much later, the IDFA 100 is run or executed at or after the runtime 62 that defines the runtime environment 42. Characters of the input string 22 are provided as an input, perhaps along with the one or more environmental strings 72 representing the runtime environment 42. The IDFA 100, though, may be repeatedly run or executed using different input strings 22 and different environmental strings 72. So, at the compile time 64, the environmental strings 72 are unknown, undefined, and/or unavailable. The interpolant pattern matching 40 treats the environmental strings 72 as the placeholders 48. The placeholders 48 in the interpolant regular expression 46 are similarly incorporated into the IDFA 100 using the register operations 114. Only after the IDFA 100 is compiled are the environmental strings 72 exposed and defined. The environmental strings 72 thus cannot influence the structure of IDFA 100, as the environmental strings 72 are unknown until the runtime 62 that defines the runtime environment 42.

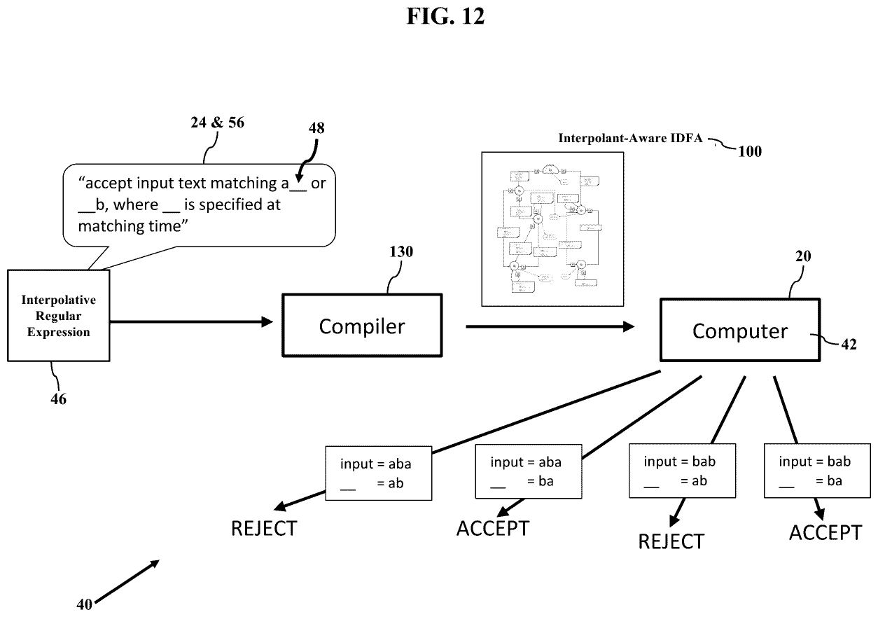

FIG. 12 illustrates still more detailed examples of the interpolant pattern matching 40. In FIG. 12, the interpolant regular expression 46 is generated by representing the pattern 24 using the interpolant string 56. The interpolant string 56, though, reserves or designates the runtime placeholder(s) 48 (such as the blank spaces 50, bit fields 52, and/or null/empty bit positions 54 illustrated in FIG. 9) that is/are populated/filled, defined, or referenced during the later runtime environment 42. A compiler 130 produces the interpolant-aware IDFA 100. Again, while the interpolant pattern matching 40 may be incorporated into any state machine, for simplicity FIG. 12 illustrates the compiler 130 constructing the single interpolant deterministic finite automata (or IDFA) 100 based on the interpolant regular expression 46. The IDFA 100 thus implements the pattern 24 defined by the interpolant regular expression 46 incorporating the interpolant string 56. The same IDFA 100 may thus be used with any combination of character/bit inputs and interpolant strings 56 to produce accept/reject decisions.

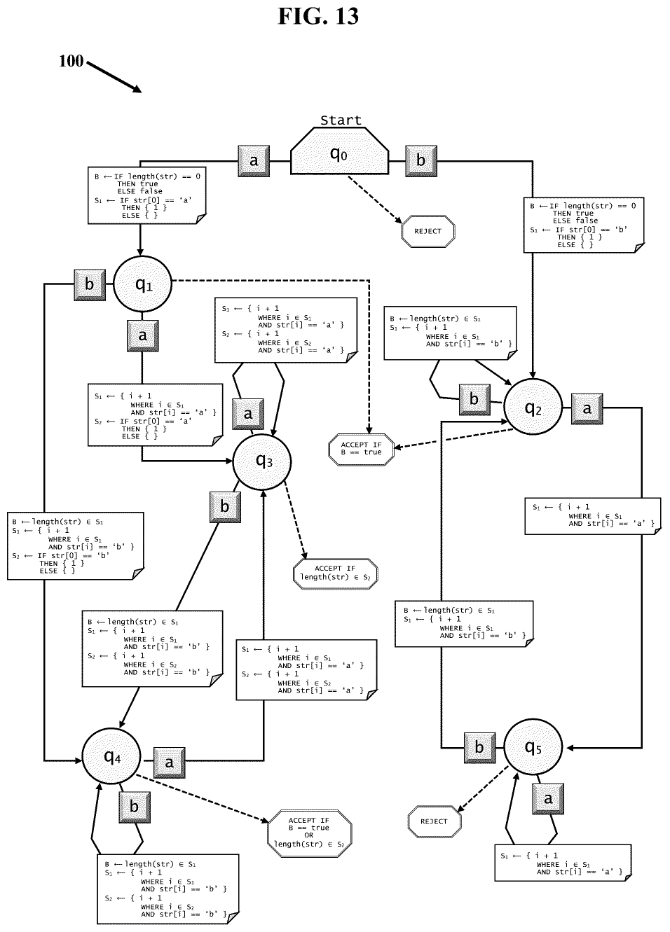

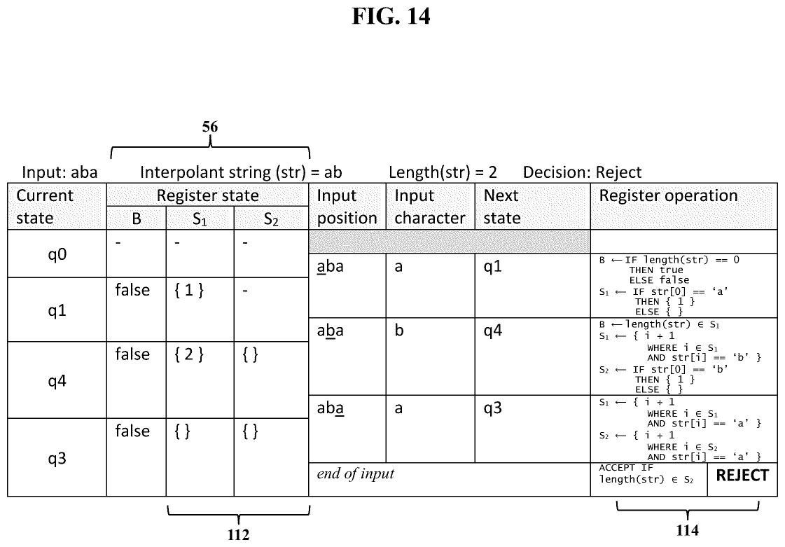

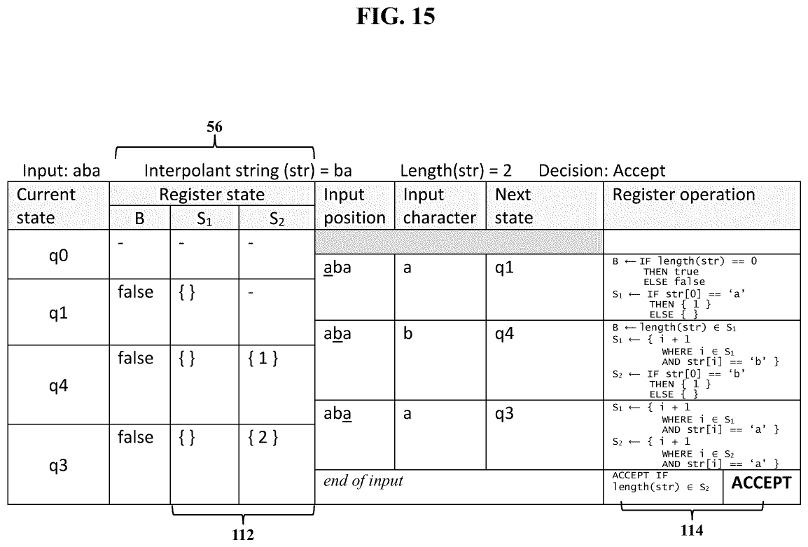

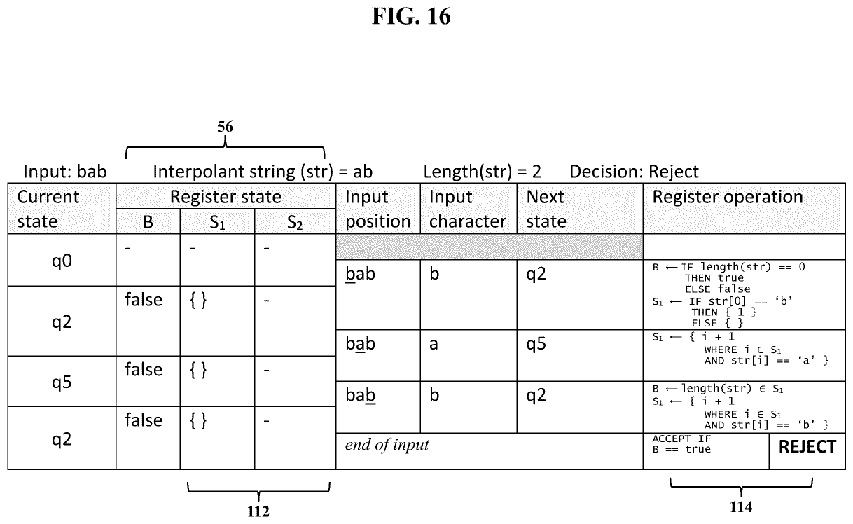

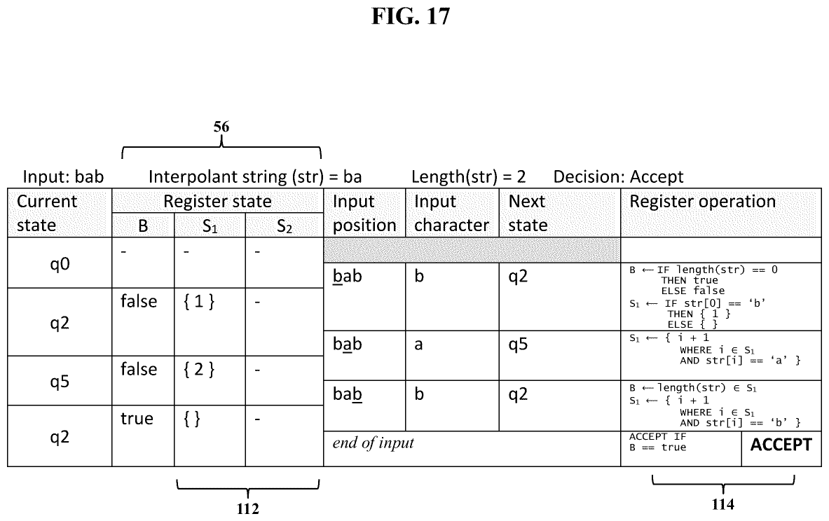

FIGS. 13-17 illustrate more examples of the interpolant deterministic finite automata (or IDFA) 100. Again, while the interpolant pattern matching 40 may be incorporated into any state machine, FIGS. 13-17 illustrate the interpolant deterministic finite automata (or IDFA 100). The IDFA 100 can match text of the form “a_” or “_b”, where is the text to interpolate at the runtime 62 (or at “match time”, being that the IDFA 100 is populated or defined after the compile time 64 and during the runtime environment 42). The IDFA 100 has six (6) states q₀₋₅ that are compared to the characters “a” or “b” of the input string 22. FIGS. 14-17 illustrate examples of the corresponding interpolant state tables that trace the execution of the IDFA 100 against the several combinations of the character inputs and the interpolant strings 56. The IDFA 100 thus matches input text of the form “a_” or “_b”, where _ is the text that is interpolated at runtime. This matching criterion can be represented by the interpolant regular expression 46 incorporating the interpolant string 56 “‘a [symbol] b’” (e.g., the placeholder 48 that is populated/filled, defined, or referenced during the runtime environment 42). The IDFA 100 operates using one Boolean-valued register B and two set-valued interpolant registers S1 and S2 (illustrated as reference numeral 112). To process an input text in the context of the interpolant string 56, the IDFA 100 begins at the initial/start state q0. By following the edges labeled by the characters of the input string 22, while performing the indicated register operations 114. In the register operations 114, ‘str’ is used to denote the interpolant string 56, and ‘str [i]’ means the character of ‘str’ at index i, counting from 0. Once the end of the input string 22 is reached, follow the dotted arrow to find the acceptance criterion, which will determine if the input matches the pattern ‘a [symbol] b’, in the runtime context where the value of ‘str’ has replaced the _.

String interpolation thus retains a linear execution time. The scratch space may be proportional to the largest input string 22. The interpolant pattern matching 40 thus has a proportional overhead, but the interpolant pattern matching 40 also has linear execution time. Conventional backtracking regular expression engines may be augmented with proportional overhead, but conventional backtracking regular expression engines do not achieve linear time processing of the input. The interpolant pattern matching 40 provides both proportional overhead and linear execution time. The interpolant pattern matching 40 thus achieves both guarantees. The IDFA 100 has a static construction for the predictable and deterministic run time, but the IDFA 100 does not consume or require an arbitrary or unknown amount of memory.

String interpolation also provides a predictable execution time. When using the IDFA 100, each read of a character from the input string 22 may transition or step within the IDFA 100. So, because the input string 22 is N characters long, the IDFA 100 will traverse exactly N steps. These N steps provide a predictable execution time. With a conventional backtracking solver, at some point partway through the input string, a bad decision may be made and thus forcing rewind and retry operation. This rewind and retry operation may re-execute many times before resolving. The interpolant pattern matching 40, in contradistinction, has the N steps and thus a predictable execution time. Because the operations 114 are acting on the sets of the runtime pointers 60, the time to run the operation 114 may depend on the size of those sets. The execution time may thus not just depend on the N size of the input string 22. The execution time also depends on the size of the interpolate strings 56. The execution time may thus linearly depend on both, but the execution time is bounded by some multiple of the sum of the lengths of the input string 22 and all the interpolate strings 56.

Predictability is important in kernel contexts. Should the pattern-matching software application 30 have the kernel-mode components 30a (as illustrated in FIG. 10), the pattern-matching software application 30 may thus operate in a restricted environment. Anywhere memory allocation is restricted (such as in the kernel 110), and/or very expensive (e.g., cloud storage), then memory allocation must be precisely bound for execution times. Because the interpolant pattern matching 40 is predictable, the interpolant pattern matching 40 is an elegant solution for improve computer functioning, cost, and time.

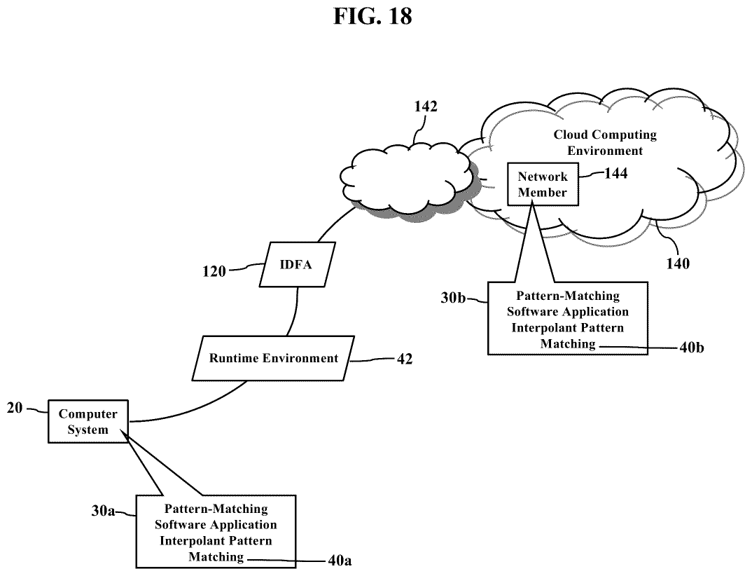

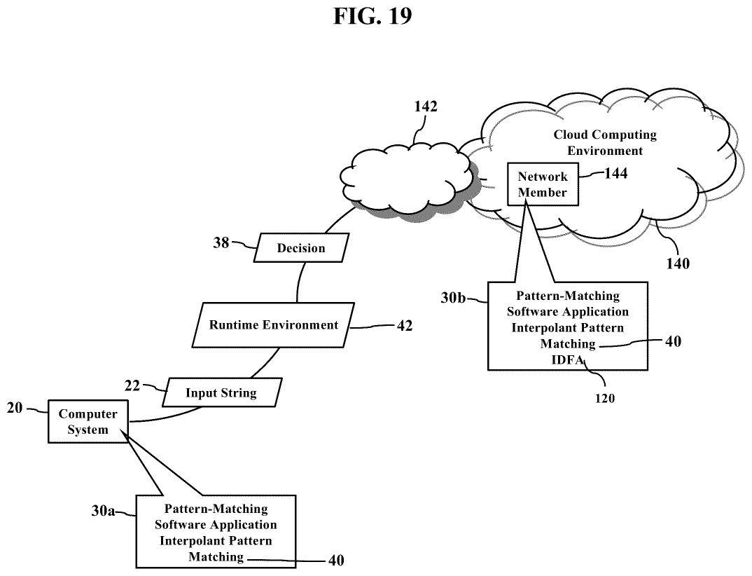

FIGS. 18-19 illustrate examples of cloud-based services. Here the computer system 20 may rely on a cloud computing environment 140 to provide at least some portions of the interpolant pattern matching 40. While the pattern-matching software application 30 may be entirely locally executed by the computer system 20, the pattern-matching software application 30 may offload or outsource some or all of the interpolant pattern matching 40 to cloud resources provided by the cloud computing environment 140. In FIG. 18, for example, the computer system 20 may have a network interface to a communications network 142. The computer system 20 may thus interface with the cloud computing environment 140 via the communications network 142. Once the computer system 20 enters the runtime environment 42, the pattern-matching software application 30 may include programming code or instructions that cause the computer system 20 to send or upload the runtime environment 42 to a network address (e.g., an Internet protocol address) associated with a network member 144 affiliated with the cloud computing environment 140. The computer system 20, for example, may send packetized messages describing the runtime environment 42 (such as the runtime value(s) 58, the runtime pointer 60, and/or the runtime bits 66 above explained). The pattern-matching software application 30 may thus have a client-side version 30a and a server-side version 30b that interface and cooperate to generate the IDFA 100. When the cloud computing environment 140 receives the runtime environment 42 associated with the computer system 20, the cloud computing environment 140 may then populate or define the IDFA 100. The cloud computing environment 140 may thus provide the IDFA 100 as an interpolant pattern matching cloud service to clients (such as the computer system 20). Once the IDFA 100 is defined or filled using the runtime environment 42, the cloud computing environment 140 may send the populated IDFA 100 via the communications network 142 to the network address (e.g., an Internet protocol address) associated with the computer system 20. When the computer system 20 receives the populated IDFA 100, the pattern-matching software application 30a may instruct the computer system 20 to store the IDFA 100 in the memory device 32 (illustrated in FIGS. 1-11). The pattern-matching software application 30a may thus pattern match the input string 22 to the IDFA 100 that represents the runtime environment 42. The client computer system 20, in other words, may execute the interpolant pattern matching 40 without consuming memory and processor operations spent populating the IDFA 100. Hardware resources may thus be reserved for other operations, thus further improving computer functioning.

FIG. 19 illustrates examples of more comprehensive cloud-based services. Here the computer system 20 may offload the interpolant pattern matching 40 to cloud resources provided by the cloud computing environment 140. The pattern-matching software application 30 may thus again have the client-side version 30a and the server-side version 30b that interface and cooperate to provide the interpolant pattern matching 40 as a cloud service. Once the computer system 20 enters the runtime environment 42, the client-side pattern-matching software application 30a may include programming code or instructions that cause the computer system 20 to send or upload the runtime environment 42 to the network member 144 affiliated with the cloud computing environment 140. Here, though, the computer system 20 may also send the input string 22 to the network member 144. The client-side pattern-matching software application 30a may thus offload both the runtime environment 42 and the input string(s) 22 for the interpolant pattern matching cloud service. The server-side version 30b may populate the DFA 100 with the runtime environment 42. The server-side version 30b may also then perform the interpolant pattern matching cloud service by executing the interpolant pattern matching 40 using the input string 22. The server-side version 30b may then generate the decision 38 and send the decision 38 via the communications network 142 to the network address (e.g., an Internet protocol address) associated with the computer system 20. The client-side pattern-matching software application 30a may thus entirely rely on cloud services for the interpolant pattern matching 40.

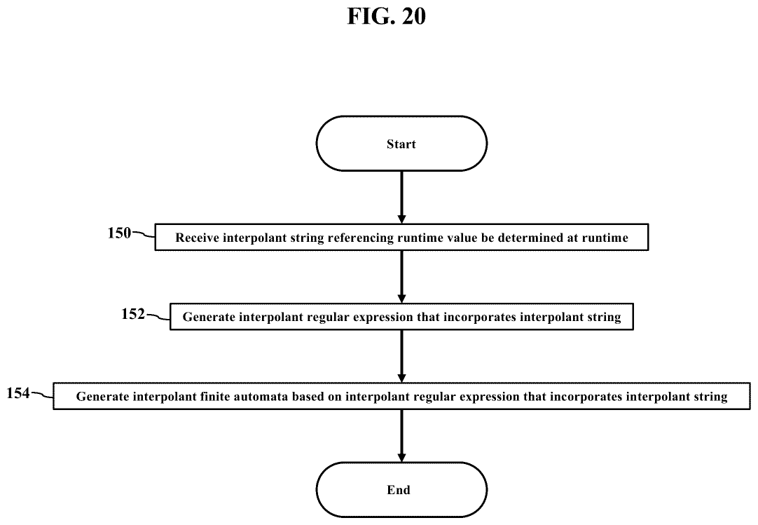

FIG. 20 illustrates examples of a method or operations that improve(s) computer functioning by generating the interpolant finite automata 44 for the interpolant pattern matching 40. The interpolant string 56 is received that references the runtime value 58 to be determined at the runtime 62 (Block 150). The interpolant regular expression 46 is generated that incorporates the interpolant string 56 (Block 152). The interpolant finite automata 44 is generated based on the interpolant regular expression 46 that incorporates the interpolant string 56 (Block 154).

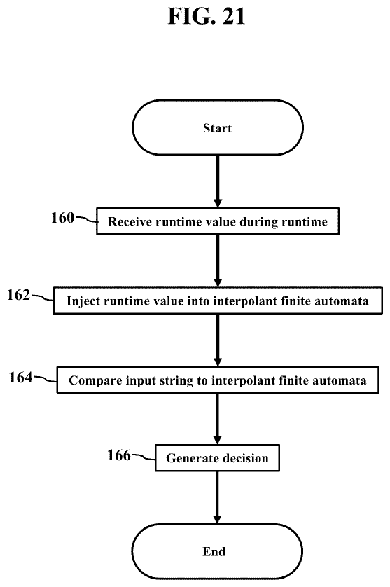

FIG. 21 illustrates more examples of a method or operations that interpolantly pattern match(es) the input string 22. The runtime value 58 associated with the runtime environment 44 is received (Block 160). The runtime value 58 is injected into the interpolant finite automata 44 (Block 162). The input string 22 is compared to the interpolant finite automata 44 having the runtime value 58 injected therein (Block 164). The decision 38 is generated (Block 166).

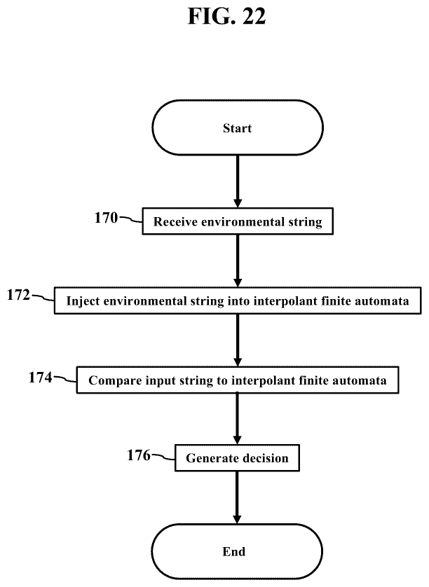

FIG. 22 illustrates still more examples of a method or operations that interpolantly pattern match(es) the input string 22. The environmental string 72 representing the environmental variable 70 determined during the runtime environment 42 is received (Block 170). The pattern 24 associated with the deterministic finite automata (DFA) is populated with the environmental string 72 (Block 172). The input string 22 is compared to the pattern 24 populated with the environmental string 72 (Block 174). The decision 38 is generated (Block 176).

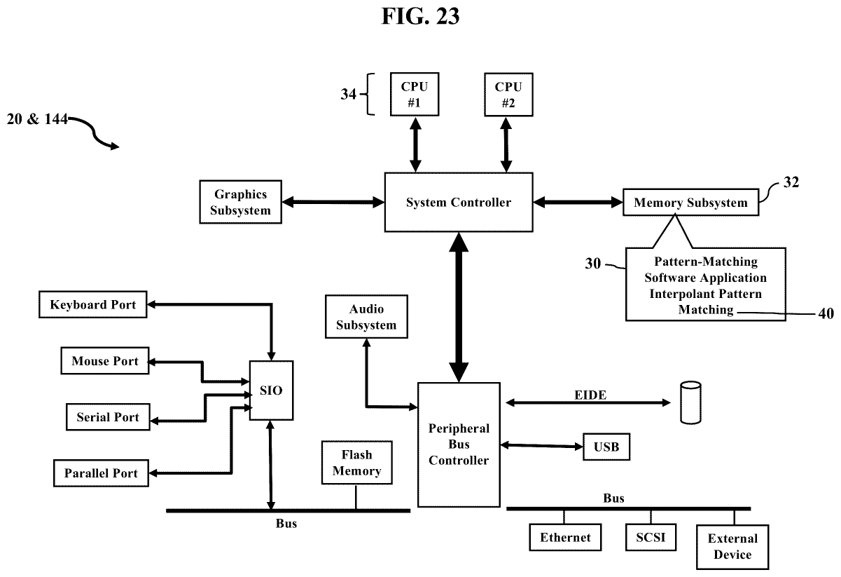

FIG. 23 illustrates a more detailed example of the operating environment. FIG. 23 is a more detailed block diagram illustrating the computer system 20 and the network member 144 of the cloud computing environment 140. The pattern matching software application 30, implementing the interpolant pattern matching 40, is stored in the memory subsystem or device 32. One or more of the processors 34 communicate with the memory subsystem or device 32 and execute the pattern matching software application 30. Examples of the memory subsystem or device 30 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology.

The computer system 20 and the network member 144 may have any embodiment. As this disclosure explains, the computer system 20 and the network member 144 may be embodied as any processor-controlled information handling system. The computer system 20 and the network member 144 may be embodied as a server, a switch, a router, a storage component, and/or a management component. The computer system 20 and the network member 144 may also be embodied as a smartphone, a tablet computer, a smartwatch, a television, an audio device, a remote control, and/or a recorder. The computer system 20 and the network member 144 may also be embodied as a smart appliance, such as washers, dryers, and refrigerators. Indeed, as cars, trucks, and other vehicles grow in electronic usage and in processing power, the pattern matching software application 30, implementing the interpolant pattern matching 40, may be easily incorporated into any vehicular controller.

The above examples of interpolant pattern matching 40 may be applied regardless of the networking environment. The pattern matching software application 30, implementing the interpolant pattern matching 40, may be easily adapted to execute in stationary or mobile devices having wide-area networking (e.g., 4G/LTE/5G cellular), wireless local area networking (WI-FI®), near field, and/or BLUETOOTH® capability. The pattern matching software application 30, implementing the interpolant pattern matching 40, may be applied to stationary or mobile devices utilizing any portion of the electromagnetic spectrum and any signaling standard (such as the IEEE 802 family of standards, GSM/CDMA/TDMA or any cellular standard, and/or the ISM band). The pattern matching software application 30, implementing the interpolant pattern matching 40, however, may be applied to any processor-controlled device operating in the radio-frequency domain and/or the Internet Protocol (IP) domain. The examples may be applied to any processor-controlled device utilizing a distributed computing network, such as the Internet (sometimes alternatively known as the “World Wide Web”), an intranet, a local-area network (LAN), and/or a wide-area network (WAN). The examples may be applied to any processor-controlled device utilizing power line technologies, in which signals are communicated via electrical wiring. Indeed, the many examples may be applied regardless of physical componentry, physical configuration, or communications standard(s).

The computer system 20 and the network member 144 may utilize any processing component, configuration, or system. For example, the examples may be easily adapted to any desktop, mobile, or server central processing unit, graphics processor, ASIC, or chipset offered by INTEL®, ADVANCED MICRO DEVICES®, ARM®, APPLE®, TAIWAN SEMICONDUCTOR MANUFACTURING®, QUALCOMM®, or any other manufacturer. The computer system 20 and the network member 144 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The examples may inspect packetized communications. When the computer system 20 and the network member 144 communicates via any communications network, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The examples may utilize any signaling standard. The cloud computing environment 140, for example, may mostly use wired networks to interconnect the network members 144. However, the cloud computing environment 140 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud computing environment 62 may also utilize other standards, such as the I.E.E.E. 802 family of standards, the Industrial, Scientific, and Medical band of the electromagnetic spectrum, BLUETOOTH®, low-power or near-field, and any other standard or value.

The pattern matching software application 30, implementing the interpolant pattern matching 40, may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for performing the interpolant pattern matching 40, as the above paragraphs explain.

The diagrams, schematics, illustrations, and the like represent conceptual views or processes illustrating examples of the interpolant pattern matching 40. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that generates an interpolant finite automata for interpolant pattern matching, comprising:
receiving, by the computer system, an interpolant string referencing a runtime value to be determined at a runtime;
generating, by the computer system, an interpolant regular expression that incorporates the interpolant string that references the runtime value; and
generating, by the computer system, the interpolant finite automata that references the runtime value for the interpolant pattern matching based on the interpolant regular expression.

2. The method of claim 1, wherein the generating of the interpolant finite automata further comprises compiling the interpolant regular expression.

3. The method of claim 1, further comprising establishing an interpolant register associated with the interpolant string that references the runtime value.

4. The method of claim 1, further comprising populating the interpolant finite automata with the runtime value determined at the runtime.

5. The method of claim 1, further comprising reserving a runtime placeholder within the interpolant string that references the runtime value to be determined at the runtime.

6. The method of claim 1, further comprising incorporating into the interpolant finite automata an environmental variable to be determined at the runtime.

7. The method of claim 1, further comprising incorporating into the interpolant finite automata a file location to be determined at the runtime.

8. A computer system that pattern matches an input string, comprising:
a central processing unit; and
a memory device storing instructions that, when executed by the central processing unit, perform operations, the operations comprising:
receiving a runtime value associated with a runtime environment;
injecting the runtime value into an interpolant finite automata; and
comparing a character associated with the input string to the interpolant finite automata having the runtime value injected therein.

9. The computer system of claim 8, wherein the operations further comprise executing the interpolant finite automata having the runtime value injected therein.

10. The computer system of claim 8, wherein the operations further comprise generating the interpolant finite automata.

11. The computer system of claim 10, wherein the operations further comprise generating an interpolant deterministic finite automata as the interpolant finite automata.

12. The computer system of claim 8, wherein the operations further comprise injecting the runtime value into an interpolant string.

13. The computer system of claim 8, wherein the operations further comprise:
receiving an environmental variable; and
injecting the environmental variable into the interpolant finite automata.

14. The computer system of claim 8, wherein the operations further comprise:
receiving a directory path; and
injecting the directory path into the interpolant finite automata.

15. The computer system of claim 8, wherein the operations further comprise:
receiving a runtime pointer determined during the runtime environment; and
injecting the runtime pointer into the interpolant finite automata.

16. A memory device storing instructions that, when executed by a central processing unit, perform operations that pattern match an input string, the operations comprising:
receiving an environmental string representing an environmental variable determined during a runtime environment;
populating a pattern associated with an interpolant deterministic finite automata (IDFA) with the environmental string representing the environmental variable; and
comparing a character associated with the input string to the pattern populated with the environmental string representing the environmental variable.

17. The memory device of claim 16, wherein the operations further comprise inserting the environmental string into the IDFA.

18. The memory device of claim 16, wherein the operations further comprise determining a match based on the comparing of the character to the pattern populated with the environmental string representing the environmental variable.

19. The memory device of claim 16, wherein the operations further comprise inserting the environmental string into an interpolative string associated with the pattern.

20. The memory device of claim 16, wherein the operations further comprise injecting the environmental string into a runtime placeholder associated with the IDFA.
